(19) United States
(12) Patent Application Publication
(10) Pub. No.: US 2004/0070488 A1
(43) Pub. Date: Apr. 15, 2004

(54) Method and device for coding and/or reading information and/or authorisation data on a data carrier

(76) Inventor: Rudolf Stockhammer, Gartenau (AT)

Correspondence Address: Flynn Thiel, Boutell & Tanis, 2026 Rambling Road, Kalamazoo, MI, 49008-1631, US

(21) Appl. No.: 10/416,869

(22) PCT Filed: Nov. 8, 2001
(86) PCT No.: PCT/EP01/12953

(30) Foreign Application Priority Data
Nov. 15, 2000 (DE) 10056521.2

(51) Int. Cl. G06F 17/60; H04Q 1/00

(52) U.S. Cl. 340/5.61; 705/5

(57) ABSTRACT

A system which can be accessed by means of a coded data carrier via access terminals which are provided with a device for reading the data carrier. In order to code the access authorisation data on the data carrier, the person wishing to obtain access has both a data carrier and a device for coding the data carrier. The person concerned communicates the desired access authorisation, via a telecommunication device, to a web server which accounts the access authorisation, and transmits the access authorisation data, via the telecommunication device, to the device for coding the data carrier.

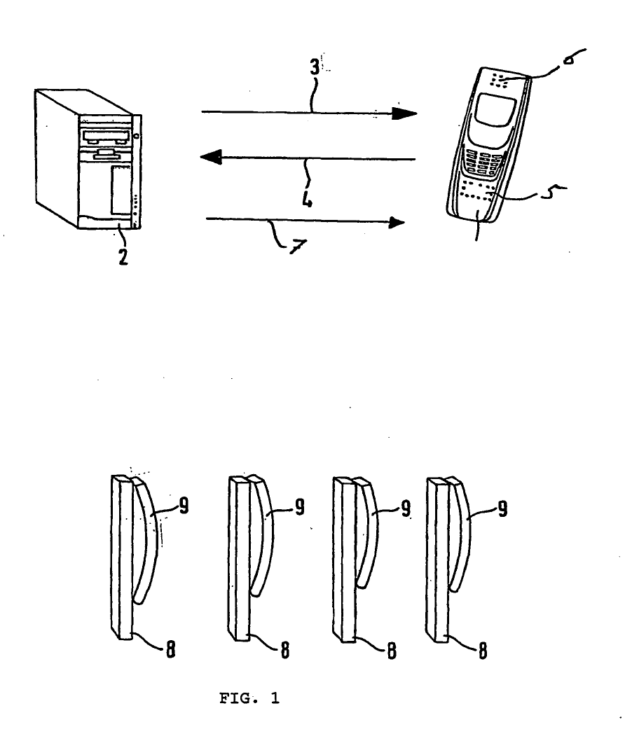

This invention relates to a method for coding and/or reading information and authorization data on a data carrier for a facility accessible with the coded data carrier via an access terminal provided with a device for reading and/or writing to the data carrier. It also relates to an apparatus for carrying out this method.

Such access terminals are provided in particular at the lifts of winter sports facilities. The data carriers used are in particular contactlessly communicating data carriers, in particular RF transponders, which are also supplied with energy for data communication at the access terminal. The contactlessly communicating data carrier can be e.g. integrated into a wristwatch or a card that can be fastened to a garment.

The purchased access authorization, for example a day ski pass for an adult, is coded on the data carrier at the ticket office of the winter sports facility. The purchase together with the coding thus takes a certain time. However, the ticket office of a winter sports facility often has such a great onrush, especially in the morning, that long waiting periods at the ticket offices are among the agonizing experiences of many winter sportspeople.

DE 197 06 174 A1 discloses a mobile phone wherein the smart card (SIM card) required for using the mobile phone can be loaded with the mobile phone via the network with data which are transferred contactlessly from the smart card through the casing of the mobile phone alternately to devices such as money dispensing machines or time recording and access authorization systems.

The problem of the invention is to provide a method and apparatus for coding and/or reading a data carrier with access authorization data without having to use a ticket office.

This is obtained according to the invention with the method characterized in claim 1. Claims 2 to 5 render preferred embodiments of the inventive method. Preferred apparatuses for carrying out the inventive method are the object of claims 5 to 9.

The authorization that the person reports to the EDP platform is for example an access authorization. The EDP platform may be intended e.g. for reservations, bookings or transactions and formed e.g. by a Web server.

The data carrier used is in particular an electronic data carrier with a codable microchip. The electronic data carrier may be a contact-type data carrier, but preferably a contactless-type electronic data carrier is used in the form of a transponder consisting of a carrier plate or foil with a microchip and an antenna.

The access terminal can be provided at a lift or cable car of a winter sports facility. It has a device for reading the data of the data carrier and optionally for coding new data on the data carrier. If the data carrier is an RF transponder, the access terminal at the same time supplies the data carrier with the energy required for data communication. When access authorization is detected, the terminal unblocks a turnstile or similar person singling device.

The inventive method is intended primarily for coding access authorizations for winter sports facilities, but it is also employable for coding authorization for other recreational, sports and entertainment facilities, such as amusement parks, swimming pools, parks, large events and fairs, i.e. in general for all facilities accessible with a valid data carrier via an access terminal.

The person desiring access authorization requires for the inventive method not only the data carrier but also a telecommunication device for reporting the desired access authorization data, for example skiing area, period of validity, e.g. day pass, type of card, e.g. adult or child, name of access-authorized person and the like, to a Web server, as well as a coding device permitting the Web server or other EDP platform to code the desired authorization data and/or information on the data carrier via the same or another telecommunication device.

The coding device can be a conventional module for contact-type or contactless coding of data on an electronic data carrier, e.g. an RF transponder. The telecommunication device can be a telephone and/or the Internet.

The telecommunication device used can be in general any mobile or stationary telecommunication terminal; telephone and Internet are thus only examples.

The desired authorization and/or information can be reported to the Web server or EDP platform e.g. with a mobile phone. The mobile phone is for this purpose preferably provided with the coding device for coding the information and/or authorization data on the data carrier.

Communication of the mobile phone with the Web server or other EDP platform can be effected e.g. by SIM (short message service) or WAP (wireless application protocol), in particular also according to the UMTS or similar high-speed data communication technology. Likewise, communication between the Web server and the coding device with which the mobile phone is preferably provided is effected in particular by SMS, WAP, UMTS and similar technologies.

According to the invention, modern communication terminals and infrastructures, e.g. technology platforms and/or protocols, are thus preferably used. The communication medium can be in particular a mobile communication terminal having the form of a wristwatch. It is also possible to transmit the authorization data and/or information to the EDP platform, e.g. the Web server, and perform the coding of the data carrier with the coding and/or reading device by Bluetooth wireless technology e.g. over the Internet. Likewise, the coded data on the data carrier can be read by the coding/reading device by Bluetooth wireless technology.

The person acquiring authorization, for example the winter sportsperson, e.g. when arriving at the winter sports area or other facility or event, dials on his mobile phone the phone number existing for coding access authorizations for the relevant facility or event, and then transfers the desired access authorization data, for example by SMS or WAP.

These data are forwarded to the EDP platform, which firstly bills the desired authorization and secondly transfers the authorization data to the coding and/or reading device, which then codes them on the data carrier. The data carrier is thus valid, so that no coding at the ticket office or the access terminal is required.

The data carrier and/or the device for reading and/or coding the data carrier can be provided in or on the cover of the mobile phone. In addition, the battery pack of the mobile phone is especially suitable for receiving the data carrier and/or the device for coding and/or reading the data carrier, since it is a separately obtainable, retrofittable part of a mobile phone. The mobile communication device can also have the form of a wristwatch.

Coding with one's own mobile phone permits especially stress-free coding, far from the access terminal, but it is also possible to install in certain places publicly accessible devices for coding and/or reading the data carrier that are connected to the Internet.

Likewise, transfer of the desired access authorization data can be effected between a PC and a Web server. Preferably, the reading and/or coding device is then provided in or on an accessory that is connectable to the PC or contactless, for example the mouse pad, the mouse, the keyboard of the PC or another peripheral unit.

Billing of the booked access authorization can be effected for example via the telephone bill in case of a telephone, or as usual by an e-commerce procedure, e.g. with a credit card, in case of Internet coding.

In the following the invention will be explained in more detail with reference to the enclosed drawing, whose single FIGURE shows a block diagram of an embodiment of the inventive method.

Accordingly, an offer e.g. for skiing areas, prices, etc., is obtained from Web server 2 with mobile phone 1 according to arrow 3.

Mobile phone 1 has data carrier 5 (shown by dotted lines), for example an RF transponder with a microchip, and coding device 6 (shown by dotted lines) for coding data carrier 5 or the microchip.

After the offer is obtained, the access authorization can be coded on data carrier 5 for the selected winter sports area. For this purpose, the desired access authorization data, such as skiing area, day pass, adult, etc., are transferred to server 2 with mobile phone 1 according to arrow 4. Besides billing the desired access authorization, server 2 forwards these data according to arrow 7 to coding device 6 of mobile phone 1, which codes these data on data carrier 5 or its microchip. The coded data carrier can be used to pass access terminals 8 provided with device 9 for reading data carrier 5.

Transfer of the authorization data to Web server 2 and coding of data carrier 5 with coding device 6 can also be effected by Bluetooth wireless technology over the Internet, as described in www.bluetooth.com. Likewise, the coded data on data carrier 5 can be read by device 9 by Bluetooth wireless technology.

1. A method for coding and/or reading information and/or authorization data on a data carrier for a facility accessible with the coded data carrier via an access terminal provided with a device for reading and/or writing to the data carrier, characterized in that the person having a data carrier (5) and a device (6) for reading and/or coding the data carrier (5) reports the desired authorization and/or information via a telecommunication device to an EDP platform that bills the access authorization and transfers the access authorization data and/or information via the telecommunication device to the device (6) for coding and/or reading the data carrier (5).

2. A method according to claim 1, characterized in that a data carrier (5) with at least one microchip is used for coding and/or reading the access authorization data.

3. A method according to claim 2, characterized in that a contactless-type data carrier (5) is used.

4. A method according to any of the above claims, characterized in that a mobile or stationary telecommunication terminal is used as a telecommunication device.

5. An apparatus for carrying out the method according to any of the above claims, characterized in that the device (6) for reading and/or coding the data carrier (5) is provided in or on an accessory that is connectable to a PC or other infrastructure or is contactless.

6. An apparatus according to claim 5, characterized in that the accessory that is connectable to the PC or contactless is a mouse pad, the mouse, the keyboard or another peripheral unit.

7. An apparatus for carrying out the method according to any of claims 1 to 4, characterized in that the device (6) for reading and/or coding the data carrier (5) is disposed in or on a communication terminal.

8. An apparatus according to claim 7, characterized in that the communication medium is a mobile communication terminal (1) in or on which the data carrier (5) and the device (6) for reading and/or coding the data carrier (5) are disposed.

9. An apparatus according to claim 8, characterized in that the communication medium is a mobile communication terminal (1) executed in the form of a wristwatch.
